(19) United States
(12) Patent Application Publication
(10) Pub. No.: US 2025/0315252 A1
(43) Pub. Date: Oct. 9, 2025

(54) METHODS AND SYSTEMS FOR STREAMLINING CODE REVIEWS

(71) Applicant: Grammarly Inc., San Francisco, CA (US)

(72) Inventors: Yarik Yermilov, Kyiv (UA); Ling Huang, Santa Clara, CA (US)

(21) Appl. No.: 19/171,251

(22) Filed: Apr. 5, 2025

Related U.S. Application Data
(60) Provisional application No. 63/575,105, filed on Apr. 5, 2024.

(51) Int. Cl. G06F 8/71; G06F 11/362

(52) U.S. Cl. CPC G06F 8/71; G06F 11/3624

(57) ABSTRACT

Disclosed is a computer-implemented technique that may include accessing one or more data sets of information associated with an undeployable version of at least a portion of an in-development software application. The undeployable version includes a copy of at least a portion of a deployable version. The technique further may include generating a prompt based on the one or more data sets of information, where generating the prompt includes generating a plurality of sub-prompts to be provided to a machine-learning model trained to generate a prediction of a summary of a merge request, which is a request to merge the at least a portion of the undeployable version with the deployable version. The technique further may include inputting the prompt into the machine-learning model, which outputs the prediction of the summary of the merge request, where the prediction includes an indication of a set of edits to the undeployable version.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. @2023-2025 Grammarly, Inc.

### RELATED APPLICATION

This application claims the benefit of U.S. provisional patent application No. 63/575,105 filed on Apr. 5, 2024, which is incorporated by reference herein in its entirety.

### TECHNICAL FIELD

One technical field of the present disclosure is code review processes and systems. Another technical field is generative artificial intelligence (AI).

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Code reviews, also called peer reviews, generally act as a quality assurance of code during the development phase of a software development workflow associated with an in-development software application. For example, code reviews may facilitate designers and developers in ensuring and improving the quality of the code before, for example, the code is merged onto the master branch of the software development workflow and deployed. Specifically, after a software developer has completed coding, for example, a subsequent code review may be utilized to elicit a second opinion on the solution and/or implementation before the code is merged onto the master branch and deployed.

For example, a developer may elicit one or more reviewers or approvers by way of a pull request or a merge request to, for example, assist with identifying bugs within the code, logic inconsistencies with the code, or other potential issues prior to merging onto the master branch and deployment. However, in many instances, approvers may become inundated with merge requests, which may vary in complexity, delivery time, developer skill level and style, and so forth. This may often lead to inefficiencies, interruptions, and impediments to the progression of the software development workflow.

### BRIEF DESCRIPTION OF THE DRAWINGS

In the drawings:

FIG. 1 illustrates a distributed computer system showing the context of use and principal functional elements with which one embodiment could be implemented.

FIG. 2 illustrates an example code review computing system and machine-learning model manager system.

FIG. 3 illustrates an example workflow diagram for automatically generating a summary of a merge request for streamlining a code review process.

FIG. 4 illustrates an example workflow diagram of a map-reduce technique as utilized by a prompt generation service for eliciting a response of a prediction of a summary of a merge request.

FIG. 5 illustrates a flow diagram of an example method for automatically generating a summary of a merge request for streamlining a code review process.

FIG. 6 illustrates a computer system with which one embodiment could be implemented.

### DETAILED DESCRIPTION

### 1. General Overview

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 2. Structural & Functional Overview

### 2.1 Distributed Computer System Example

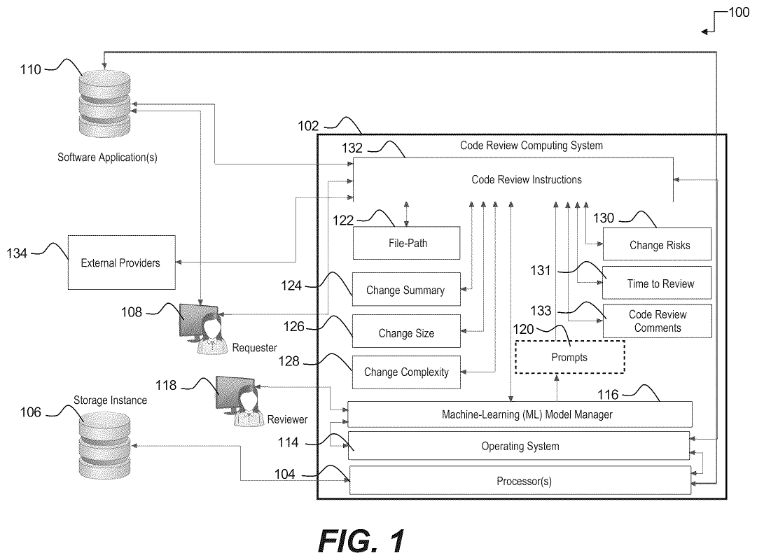

FIG. 1 illustrates a distributed computer system showing the context of use and principal functional elements with which one embodiment could be implemented. In an embodiment, a computer system organized as a code review computing system 102 may include components implemented partially by hardware at one or more computing devices, such as one or more hardware processors 104 executing stored program instructions stored in one or more storage instances 106 for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement. In certain embodiments, a requester computer system 108 may be utilized, for example, by a developer to code one or more in-development software applications stored in a database 110. The requester computer system 108 is communicatively coupled to the database 110, which may be or include a relational database suitable for storing one or more data sets of information associated with an in-development software application. For example, in some embodiments, the database 110 may store one or more data sets of textual documents (e.g., code scripts, documents, text files, code comments, and so forth) or textual messages (e.g., text messages, chat messages, posts, transcripts, and so forth) that may be associated with an in-development software application stored in the database 110. In one embodiment, the database 110 may store at least a portion of an undeployable version of the in-development software application and a deployable version. In this context, a “deployable” software application may be defined as a software application that has passed all stages of testing, review and approval required for it to be released to the intended customers/end users. In contrast, an “undeployable” software application may be defined as a software application that has not passed all such necessary stages of testing, review and approval required for it to be released to the intended customers/end users. An undeployable version may include a copy of at least a portion of the deployable version of the software application.

In certain embodiments, the code review computing system 102 may be coupled to at least one storage instance 106. The code review computing system 102 may include one or more processors 104, which host or execute system services, primitives, or libraries, which may be integrated into an operating system 114. In one embodiment, the code review computing system 102 may include one or more virtual compute instances in a private data center or public, cloud computing-based data center, and the storage instance 106 may include one or more virtual storage instances. Alternatively, the code review computing system 102 can use an on-prem implementation in one or more server computers, server clusters, or other networked computers.

The code review computing system 102 hosts or executes a set of code review instructions 132 and a machine-learning model manager 116, each including one or more computer programs, endpoints, services, methods, or functions that interoperate to execute the functions described in other sections. In general, the code review instructions 132 are programmed to generate and transmit patch files, diffs, pull requests, merge requests, summaries of merge requests, and so forth to reviewer computing devices 118 and receive updates, revisions, or comments from one or more reviewers or approvers, like designers, engineers, or other developers, associated with the reviewer computing devices 118.

In certain embodiments, the machine-learning model manager 116 may include a software system, a software service, or other similar system that may be suitable for generating prompts 120 based on the one or more data sets of information associated with an in-development software application stored to the relational database 110 to be provided to a machine-learning model for generating a summary of a merge request for facilitating review and approval by one or more reviewers or approvers associated with the reviewer computing devices 118. The machine-learning model can be one or more large language models (LLMs), coding LLMs, or similar generative AI systems. Reviewers or approvers, for purposes of this disclosure, could be other developer peers, designers, managers, or third parties. As used herein, a “prompt” may refer to, for example, any text or set of textual data that may be provided to a language model (LM) or LLM to elicit a response from the LM or LLM in accordance with a user intent. For example, in one embodiment, the “prompt” may be sent to an API of the LM or LLM, in which the prompt may be utilized to instruct the LM or LLM and guide the response of the LM or LLM toward a specific content, specific intent, and/or specific context. The summary may include specific dimensions/features of code changes represented in the merge request, such as an estimate of the amount of time required to review the merge request, whether the merge request contains any potential security issues, whether the number and complexity of changes represented by the code request is large or small, etc.

For example, in certain embodiments, the code review computing system 102 may access one or more data sets of textual documents, such as code scripts, documents, text files, code comments, and so forth, that may be associated with an in-development software application. The code review computing system 102 may also access textual messages, such as text messages, chat messages, posts, transcripts, and so forth) that may be associated with an in-development software application. In certain embodiments, the code review computing system 102 may then extract data including, for example, file-path data 122, change summary data 124, change size data 126, change complexity data 128, change risks data 130, time to review data 131, and code review comments data 133.

In some embodiments, the file-path data 122 may include a URL link to the merge request, and the change summary data 124 may include a summary of the set of edits to the undeployable version with respect to the deployable version of the in-development software application (e.g., differences between the undeployable version and the deployable version). The change size data 126 may include an indication of whether the merge request includes a “small,” “medium,” or “large” file, and the change complexity data 128 may include an indication of whether the merge request includes a “simplex,” “moderate,” or “complex” set of edits. The change risks data 130 may include an indication of whether the set of edits to the undeployable version includes sensitive information or similar data privacy risks). In some embodiments, the time to review data 131 may include an indication of a time estimate (e.g., in terms of hours or minutes) for reviewing the merge request, and the code review comments data 133 may include any review comments that may be included by one or more approvers or other entities requested to review the merge request.

In certain embodiments, the machine-learning model manager 116 may be suitable for generating the prompt 120 in a specified format, and then further calling the machine-learning model to generate a prediction of a summary of a merge request in the specified format. For example, as will be discussed in greater detail below, the machine-learning model manager 116 may generate the prompt 120 and access the data to be included in the generated summary of a merge request, send the prompt 120 to an API of the LLM, and receive via the API of the LLM a response to the prompt 120 as generated by the LLM. The data to be included in the summary can be the file-path data 122, the change summary data 124, the change size data 126, the change complexity data 128, the change risks data 130, the time to review data 131, and the code review comments data 133.

TABLE 1 shows a complete example of a prompt with sections engineered to produce a useful summary of a merge request. In certain embodiments, the prompt may be generated in an iterative process by sending one or more preliminary prompts, or “meta-prompts,” to the LLM, to successively refine the outputs to produce a final prompt, which is to be submitted to the LLM for generating the summary of the merge request. The example prompt shown in Table 1 includes multiple preliminary prompts, or meta-prompts, where the beginning of each meta-prompt is indicated by the characters “[INST]” and the end of each meta-prompt is indicated by the characters “[/INST].”

In certain embodiments, the machine-learning model manager 116 may include one or more sets of program instructions that are programmed to receive queries or prompts from one of the reviewer computing devices 118 and to interact with an LLM to produce a response corresponding to a prediction of a summary of a merge request. The reviewer computing devices 118 broadly represent any computing devices of developers or other coders related to or concerned with the patch files, diffs, pull requests, merge requests, summaries of merge requests, and so forth that the code review computing system 102 manages. The reviewer computing devices 118 may include, in various embodiments, laptop computers, desktop computers, network computers, or mobile computing devices.

In FIG. 1, arrows that connect computer system 108, relational database 110, incident detection system 112, code review computing system 102 or its elements, storage instance 106, and reviewer computing devices 118 represent network links. For the network links, various embodiments can use any combination of one or more local area networks, wide area networks, campus networks, or internetworks, using wired or wireless links, satellite links, or terrestrial links.

### 2.2 Code Review Computing System and ML Model Manager

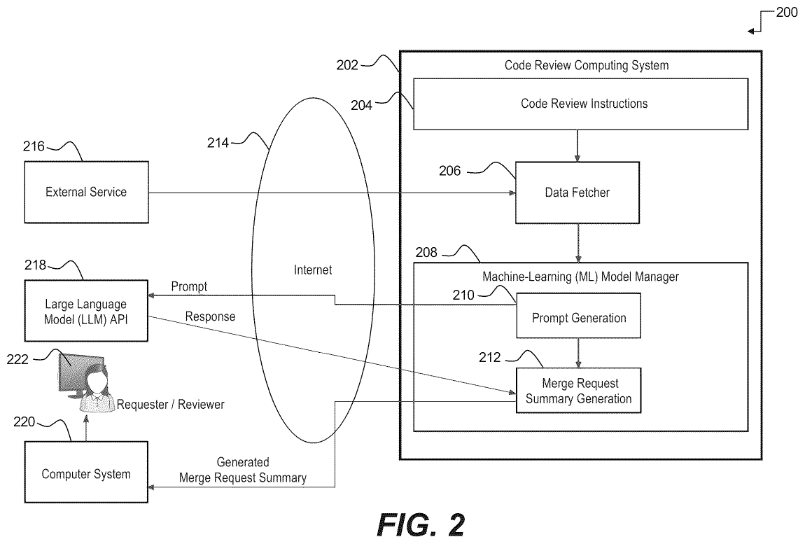

FIG. 2 illustrates an example code review computing system and machine-learning model manager system 200. As depicted, the code review computing system and machine-learning model manager system 200 include a code review computing system 202, a machine-learning model manager 208, a network 214, and an interface 218 to a large language model (LLM) of a generative AI system. In one embodiment, the code review computing system 202 may be identical to the code review computing system 102 as discussed above with respect to FIG. 1. As depicted, the code review computing system 202 may include a data fetcher 204 that is communicatively coupled logically between the code review instructions 132 and a prompt generation service 210 and a merge request summary generation service 212 within machine-learning model manager 208. In one embodiment, the machine-learning model manager 208 may be identical to the machine-learning model manager 116, as discussed above with respect to FIG. 1.

In certain embodiments, the data fetcher 204, the prompt generation service 210, and the merge request summary generation service 212 may each include program instructions programmed to execute the functions described herein. In certain embodiments, the data fetcher 206 may be programmed to request one or more data sets of textual documents or textual messages that may be associated with an in-development software application stored in the database 110. For example, in one embodiment, the data fetcher 204 is programmed to access the one or more incident event data sets stored in the relational database 110 and extract data, including, for example, file-path data 122 associated with an in-development software application, change summary data 124 associated with an in-development software application, change size data 126 associated with an in-development software application, change complexity data 128 associated with an in-development software application, change risks data 130 associated with an in-development software application, time to review data 131 associated with an in-development software application, and code review comments data 133 associated with an in-development software application, as all discussed above with respect to FIG. 1. In some embodiments, the external service 216 may broadly represent any number of independent and/or third-party networked servers, services, APIs, or database systems.

In certain embodiments, the prompt generation service 210 is programmed to generate prompts in accordance with a specified criteria and format and then further call and transmit the prompt to a machine-learning model by way of one or more LLM APIs 218 to generate a prediction of a report of an incident event in accordance with the specified criteria and format. For example, the prompt generation service 210 is programmed to generate the prompt and access the data to be included in the generated report, send the prompt to one or more LLM APIs 218, and, finally, the merge request summary generation service 212 is programmed to receive via the one or more LLM APIs 218 a response to the prompt as generated by the machine-learning model. As in prior examples, the data to be included in the report can comprise file-path data 122, change summary data 124, change size data 126, root cause data 128, and so forth, and a prompt like TABLE 1 can be used. In one embodiment, the machine-learning model may include, for example, one or more LLMs with public APIs, such as CHATGPT 3.5, CHATGPT 4.0, CHATGPT 4.5, GOOGLE BARD, LLAMA, LLAMA-2, or CODE LLAMA, or LLMs with high-grade security and that do not retain, store, or learn from prompts or contexts, such as CHATGPT ENTERPRISE. In another embodiment, the machine-learning model may include, for example, a custom-developed and trained generative pre trained transformer (GPT), a transformer-based machine learning model, or other similar sequence-to-sequence (Seq2Seq) based machine-learning model.

In certain embodiments, as previously noted, the prompt generation service 210 is programmed to generate the prompt by generating several sub-prompts to be provided by way of one or more LLM APIs 218 for generating a summary of a merge request event in a specified format. For example, in some embodiments, the prompt generation service 210 is programmed to generate the prompt utilizing one or more of an N-shot prompt technique, a chain-of-thought (COT) prompt technique, a generated knowledge prompt technique, or other similar prompt engineering technique suitable for guiding and eliciting a response from the machine-learning model by way of one or more LLM APIs 218 in accordance with specific content, specific intent, and/or specific context.

In certain embodiments, the specified format may include, for example, a JSON file including a file-path section, a change summary section, a change size section, a change complexity section, a change risks section, a time to review section, a code review comments section, and a checklist review section. In an embodiment, the file-path section comprises a URL link to the merge request. In an embodiment, the change summary section comprises a summary of the set of edits to the undeployable version with respect to the deployable version of the in-development software application. In an embodiment, the change size section comprises an indication of whether the merge request includes a “small,” “medium,” or “large” file. In an embodiment, a change complexity section comprises an indication of whether the merge request includes a “simplex,” “moderate,” or “complex” set of edits. In an embodiment, the change risks section comprises an indication of whether the set of edits to the undeployable version includes sensitive information or similar data privacy risks. In an embodiment, the time to review section comprises an indication of a time estimate for reviewing the merge request in hours or minutes or another time measure. In an embodiment, the code review comments section comprises any review comments that may be included by one or more approvers or other entities requested to review the merge request. In an embodiment, the checklist review section comprises an indication of a review rubric that one or more approvers or other entities requested to review the merge request is to follow.

In certain embodiments, the prompt generation service 210 may generate a prompt, to be sent to the LLM to generate a summary of a merge request, by sending one or more preliminary prompts, also called “meta-prompts” herein, to the LLM API 218. Further, the process of generating the final prompt for generating the summary of the request may be an iterative process that includes the prompt generation service 210 sending multiple meta-prompts sequentially to the LLM API 218, to successively refine the outputs to produce the final prompt to be submitted to the LLM for generating the summary of the merge request.

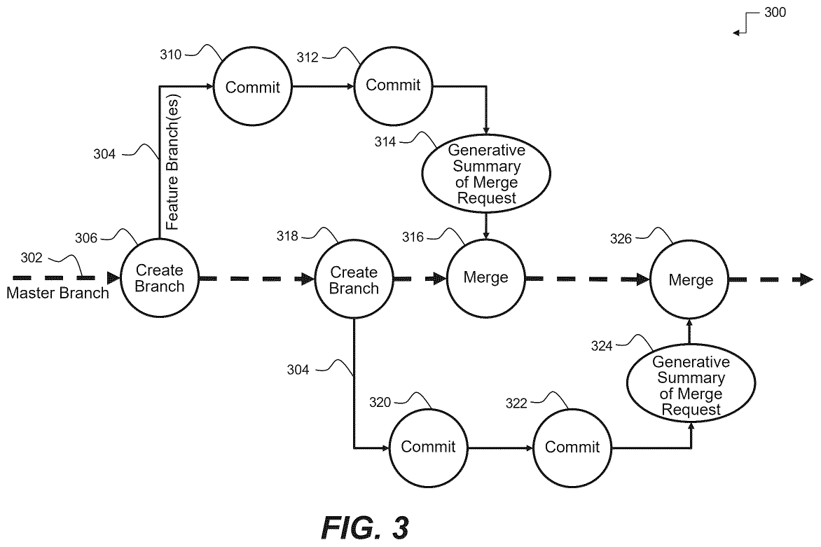

In certain embodiments, as will be further illustrated with respect to FIG. 3, the machine-learning model is programmed to generate the prediction of a summary of a merge request for the merge request to be reviewed and approved by one or more reviewers or approvers associated with the reviewer computing devices 118 before merging an undeployable version of at least a portion of the in-development software application onto the deployable version of the in-development software application.

In certain embodiments, the merge request summary generation service 212 may be suitable for receiving via the one or more LLM APIs 218 a response to the prompt as generated by the machine-learning model. For example, in certain embodiments, upon the machine-learning model receiving the prompt from the prompt generation service 210 via the one or more LLM APIs 218, the machine-learning model may then output a prediction of a summary of a merge request. Specifically, as depicted by FIG. 2, the machine-learning model may output the prediction of a summary of a merge request, and the merge request summary generation service 212 may receive via the one or more LLM APIs 218 a response corresponding to the prediction of a summary of a merge request. In one embodiment, the response received via the one or more LLM APIs 218 and corresponding to the prediction of a summary of a merge request may include a summary of a request to merge an undeployable version of the in-development software application to the deployable version of the in-development software application.

In certain embodiments, as further depicted by FIG. 2, upon receiving via the one or more LLM APIs 218 a response corresponding to a prediction of a summary of a merge request, the merge request summary generation service 212 is programmed to provide the generated summary of a merge request to a computer system 220 associated with one or more reviewers or approvers 222. For example, in some embodiments, the computer system 220 may include one or more personal devices or other computing devices that may be associated with reviewers or approvers 222, which may provide the generated summary of a merge request.

### 2.3 Workflow for Generating a Summary of a Merge Request

FIG. 3 illustrates an example of a software development workflow. In certain embodiments, the software development workflow 300 may include a workflow associated with an in-development software application, for example, during the development phase of an in-development software application. As depicted, the software development workflow 300 includes a master branch 302 and one or more feature branches 304. In certain embodiments, the master branch 302 may include a deployable version of the in-development software application and the one or more feature branches 304 may include one or more undeployable versions of the in-development software application. Those versions could be copies of the deployable version of the in-development software application.

In certain embodiments, any code, updates, or versions merged to the master branch 302 may be immediately deployed or deployed within minutes or hours. In this way, the master branch 302 may be consistent, and thus the one or more feature branches 304 may be branched off or copied from the master branch 302 and utilized as the work basis for a team of developers. In certain embodiments, when a developer desires to begin coding the in-development software application, create branch operations 306, 308 can create one or more feature branches 304 that are descriptively named off of the master branch 302. In certain embodiments, as the developer codes, one or more commits 310, 312, 320, and 322 may be performed. For example, in one embodiment, each of the one or more commits 310, 312, 320, and 322 may represent a local data store to a respective feature branch 304 and a save or push) to the same-named feature branch 304 on the database 110, for example. As previously noted, at this stage, the developer codes only to an undeployable version of the in-development software application and merges to the master branch 302 after only submission of a merge request and receiving approval from one or more reviewers or approvers associated with the reviewer computing devices 118.

For example, in certain embodiments, when a developer is ready to have code merged to the master branch 302 and deployed, the developer may submit a merge request and elicit review and approval from one or more reviewers or approvers. Specifically, once a developer determines that a respective feature branch 304 is ready to be merged with the master branch 302, after receiving review and approval from the reviewer computing devices 118, the respective feature branch 304 may be merged with the master branch 302. However, in many instances, potential reviewers or approvers may become inundated with merge requests, which may vary in complexity, delivery time, developer skill level and style, and so forth. This may often lead to inefficiencies, interruptions, and impediments to the progression of the software development workflow 300.

In an embodiment, in response to the developer selecting to submit a merge request, such as a request to merge an undeployable version of the in-development software application with the deployable version of the in-development software application, the system is programmed to generate a summary of a request to merge the undeployable version of the in-development software with the deployable version of the in-development software application. For example, in certain embodiments, a prompt may be generated and inputted into a machine-learning model by transmitting the prompt to one or more LLM APIs associated with one or more LLMs with a request to execute the inference stage over the input to generate and output a generated summary of the merge request 314, 324 of feature branches 304 with master branch 302. In one embodiment, the generated summary of the merge requests 314, 324 may include, for example, a specification or other indication of a set of edits to the undeployable version, such as feature branches 304, with respect to the deployable version, such as master branch 302 of the in-development software application.

In certain embodiments, the machine-learning model executes its inference stage over the request to output the generated summary of the merge request 314, 324 in a specified format. For example, in one embodiment, the generated summary of the merge request 314, 324 may include, for example, a JSON file including file-path data 122 associated with the merge request, change summary data 124 associated with the merge request, change size data 126 associated with the merge request, change complexity data 128 associated with the merge request, change risks data 130 associated with the merge request, time to review data 131 associated with the merge request, code review comments data 133 associated with the merge request, and a checklist review. In certain embodiments, the generated summary of the merge requests 314 and 324 may be provided to one or more reviewers or approvers associated with the reviewer computing devices 118. In certain embodiments, after receiving review and approval from the reviewer computing devices 118, one or more of the respective feature branches 304 may be merged with the master branch 302 like merge 316, 326.

In certain embodiments, before providing the generated summary of the merge request 314, 324 to one or more reviewers or approvers associated with the reviewer computing devices 118, the to one or more reviewers or approvers may be identified and selected for approving the merge request based on a specified criterion for selecting reviewers or approvers for approving merge requests. For example, in one embodiment, the specified criterion for selecting reviewers or approvers for approving merge requests may include one or more of the availability of a reviewer or approver, a likelihood of a reviewer or approver accepting the merge request, a familiarity of a reviewer or approver with a content of the merge request, a current workload of a reviewer or approver, a current connectivity status of a reviewer or approver, or a priority level associated with the merge request.

### 2.4 Prompt Generation Service Utilizing Map Reduce

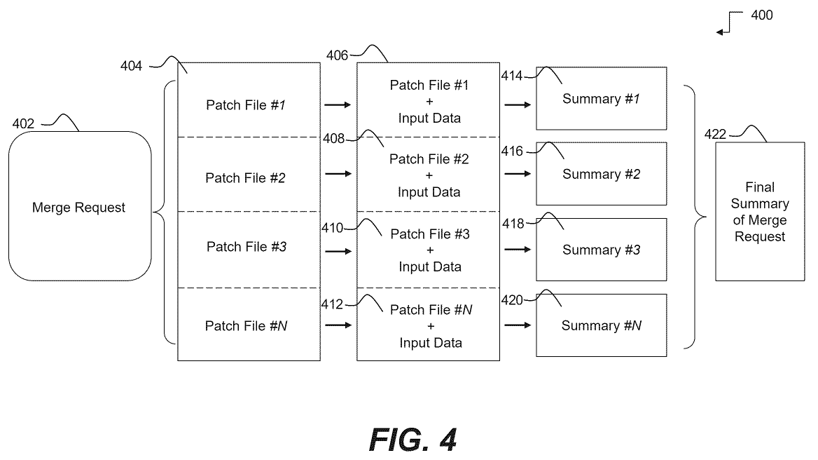

FIG. 4 illustrates an example workflow diagram 400 of a map-reduce technique that can be utilized by a prompt generation service for eliciting a response of a prediction of a summary of a merge request. In certain embodiments, the workflow diagram 400, as illustrated, may be executed by the prompt generation service 210 of the machine-learning model manager 208, as discussed with respect to FIG. 2. As depicted, the workflow diagram 400 illustrates that certain machine-learning models may include a context length or token threshold, and thus for merge requests 402 above the token threshold, the machine-learning model may underperform because the merge request 402 would otherwise be larger than the context length utilized to make a call to the machine-learning model. For example, in one embodiment, the token threshold may include, for example, a threshold of approximately 4,000 tokens, approximately 8,000 tokens, approximately 16,000 tokens, or approximately 32,000 tokens.

Thus, in certain embodiments, it may be useful for the prompt generation service 210 to execute a map-reduce technique for generating a merge request 402 in accordance with the context length or token threshold. For example, prompt generation service 210 may be programmed to execute a MapReduce Chain algorithm. In accordance with the presently disclosed embodiments, the prompt generation service 210 may execute the map reduce algorithm, which may be utilized to divide the merge request 402 into a number of subsets of information or patch files 406, 408, 410, and 412 in accordance with a token threshold associated with the machine-learning model. The subsets can comprise “chunks” of data that fit within the token threshold of the LLM or coding LLM. In one embodiment, the number of patch files 406, 408, 410, and 412 may each include a text file including differences or changes rendered on one or more of the feature branches 304, for example.

In certain embodiments, the number of patch files 406, 408, 410, and 412 may each include a context length or token limit that is less than or equal to the context length or token threshold. In certain embodiments, for each of the number of patch files 406, 408, 410, and 412, the prompt generation service 210 may then input a first prompt into the machine-learning model suitable for prompting the machine-learning model to generate a respective prediction of a textual summary 414, 416, 418, and 420 based on the number of patch files 406, 408, 410, and 412. In certain embodiments, the prompt generation service 210 may also input a second prompt into the machine-learning model suitable for prompting the machine-learning model to generate a prediction of a final textual summary 422 based on the respective predictions of textual summaries 414, 416, 418, and 420. That is, the second prompt may prompt the machine-learning model to output a final textual summary 422 that is a combined summary of the textual summaries 414, 416, 418, and 420.

### 2.5 Example of a Generated Summary Of A Merge Request

TABLE 2 illustrates an example of a summary of a merge request that can be generated by using the technique introduced herein.

TABLE 2
EXAMPLE SUMMARY

LLM-generated summary of this merge request
Expected time to review: 2-3 hours
Complexity: moderate
Size: large
Potential risks: There are some potential risks related to data
privacy and security, as the code is handling sensitive information.
Summary of changes: This merge request is a continuation of the 7-
days collection project and includes changes to the dashboard data
collection. The changes include the removal of the
AwsKmsSingleKeyHmacHasher class and the addition of a new method
for testing detailed domain app data events. The changes also include
the addition of a new field in the DomainInfo class and the removal of
the Privacy Service dependency.
Review checklist:
[X] Merge request title has a concise and meaningful explanation of
the change.
[X] Changes in code are covered by automated tests or, if not possible,
a manual testing scenario is described in the MR description.

The generated summary of a merge request may be or include a JSON file including a file-path section (e.g., a URL link to the merge request), a change summary section (e.g., a summary of the set of edits to the undeployable version with respect to the deployable version of the in-development software application), a change size section (e.g., an indication of whether the merge request includes a “small,” “medium,” or “large” file), a change complexity section (e.g., an indication of whether the merge request includes a “simplex,” “moderate,” or “complex” set of edits), a change risks section (e.g., an indication of whether the set of edits to the undeployable version includes sensitive information or similar data privacy risks), a time to review section (e.g., an indication of a time estimate (e.g., in terms of hours or minutes) for reviewing the merge request), a code review comments section (e.g., any review comments that may be included by one or more approvers or other entities requested to review the merge request), and a checklist review section (e.g., an indication of a review rubric that one or more approvers or other entities requested to review the merge request is to follow).

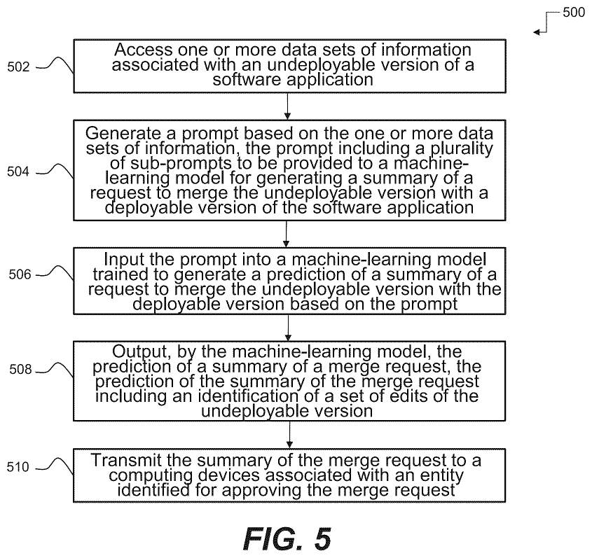

Thus, as depicted by TABLE 2, the generated summary of a merge request may generally include a brief and structured summary and a file-path link to a merge request. The generated summary of a merge request may thus facilitate the code review process of the software development workflow 300, for example, by providing one or more reviewers or approvers associated with the reviewer computing devices 118 a concise and contextually meaningful summary of a merge request for an expedited review and approval of the request to merge a respective feature branch 304 with the master branch 302, such as a request to merge an undeployable version of the in-development software application with the deployable version of the in-development software application. In one embodiment, as further depicted by FIG. 5, the generated summary of a merge request may be displayed to one or more reviewers or approvers associated with the reviewer computing devices 118 as a chat message.

In certain embodiments, one or more reviewers or approvers may also be provided and displayed a web-based user interface (UI) or dashboard including, for example, statistics regarding merge requests reviewed or to be reviewed, including actual time to review. For example, the (UI) or dashboard may allow requesting summaries of merge requests, providing suggestions for improvement, a summary of discussions of suggestions for changes based on the review, a summary of comments from other reviewers or approvers, options for executing tests of merge requests, options for inputting extensive feedback to the developers, and so forth.

### 2.6 Automatically Generating a Summary of a Merge Request

FIG. 5 illustrates a flow diagram of a method 500 for automatically generating a summary of a merge request for streamlining a code review process, in accordance with the disclosed embodiments. The method 500 may be performed utilizing one or more processing devices (e.g., one or more processors 104 as discussed above with respect to FIG. 1 or one or more processors associated with an external LLM) that may include hardware (e.g., a general-purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various incident event data and making one or more predictions or decisions based thereon), firmware (e.g., microcode), or some combination thereof.

The method 500 may begin at block 502 with the one or more processing devices (e.g., one or more processors 104) accessing one or more data sets of information associated with an undeployable version of an in-development software application. For example, in certain embodiments, the one or more processors 104 may access one or more data sets of textual documents (e.g., code scripts, documents, text files, code comments, and so forth) or textual messages (e.g., text messages, chat messages, posts, transcripts, and so forth) that may be associated with an in-development software application. In one embodiment, the undeployable version (e.g., one or more feature branches 304) of the in-development software application may include a copy of a deployable version (e.g., master branch 302) of the in-development software application.

The method 500 may continue at block 504 with the one or more processing devices (e.g., one or more processors 104) generating a prompt based on the one or more data sets of information. In certain embodiments, the one or more processors 104 may generate the prompt by generating a number of sub-prompts to be provided to a machine-learning model (e.g., LLM, Code LLM) for generating a summary of a request to merge the undeployable version (e.g., one or more feature branches 304) of the in-development software with the deployable version (e.g., master branch 302) of the in-development software application. For example, in certain embodiments, the one or more processors 104 generate one or more of an N-shot prompt, a chain-of-thought (COT) prompt, or a generated knowledge prompt that may be suitable for prompting a machine-learning model (e.g., LLM, Code LLM) to generate a summary of a request to merge the undeployable version (e.g., one or more feature branches 304) of the in-development software with the deployable version (e.g., master branch 302) of the in-development software application. Block 504 can be programmed to retrieve a prompt like TABLE 1 from storage and to use the prompt directly or with updates based on the aforementioned data.

The method 500 may continue at block 506 with the one or more processing devices (e.g., one or more processors 104) inputting the prompt into a machine-learning model trained to generate a prediction of a summary of a request to merge the undeployable version with the deployable version based on the prompt. For example, in certain embodiments, the one or more processors 104 may input the prompt into a machine-learning model by transmitting the prompt to one or more LLM APIs associated with one or more LLMs. The method 500 may continue at block 508 with the one or more processing devices outputting, by the machine-learning model, the prediction of a summary of a merge request. For example, in certain embodiments, the one or more processors 104 may receive as a response to the prompt an output of the machine-learning model (e.g., LLM, Code LLM), in which the output may include a prediction of a summary of the merge request. In one embodiment, the summary of the merge request may include, for example, an identification of a set of edits to the undeployable version (e.g., one or more feature branches 304) with respect to the deployable version (e.g., master branch 302) of the in-development software application.

For example, in accordance with the presently disclosed embodiments, the machine-learning model (e.g., LLM, Code LLM) may generate a prediction of a summary of a merge request in a specified format. In one embodiment, the specified format may include, for example, a JSON file including a file-path section (e.g., a URL link to the merge request), a change summary section (e.g., a summary of the set of edits to the undeployable version with respect to the deployable version of the in-development software application), a change size section (e.g., an indication of whether the merge request includes a “small,” “medium,” or “large” file), a change complexity section (e.g., an indication of whether the merge request includes a “simplex,” “moderate,” or “complex” set of edits), a change risks section (e.g., an indication of whether the set of edits to the undeployable version includes sensitive information or similar data privacy risks), a time to review section (e.g., an indication of a time estimate (e.g., in terms of hours or minutes) for reviewing the merge request), a code review comments section (e.g., any review comments that may be included by one or more approvers or other entities requested to review the merge request), and a checklist review section (e.g., an indication of a review rubric that one or more approvers or other entities requested to review the merge request is to follow).

The method 500 may conclude at block 510 with the one or more processing devices (e.g., one or more processors 104) transmitting the summary of the merge request to one or more computing devices associated with an entity identified for approving the merge request. For example, in one embodiment, upon receiving as a response to the prompt the output of the machine-learning model (e.g., LLM, coding LLM) corresponding to a summary of a merge request, the one or more processors 104 may then transmit the generated summary of the merge request to one or more computing devices associated with one or more approvers or other entities requested to review the merge request.

In certain embodiments, prior to transmitting the summary of the merge request to the one or more computing devices associated with one or more approvers or other entities requested to review the merge request, the one or more processors 104 may select the entity identified for approving the merge request based on a specified criterion for selecting entities for approving merge requests. For example, in one embodiment, the specified criterion for selecting entities for approving merge requests may include, for example, an availability of an entity, a likelihood of an entity to accept the merge request, a familiarity of an entity with a content of the merge request, a current workload of an entity, a current connectivity status of an entity, or a priority level associated with the merge request.

### 3. Implementation Example-Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

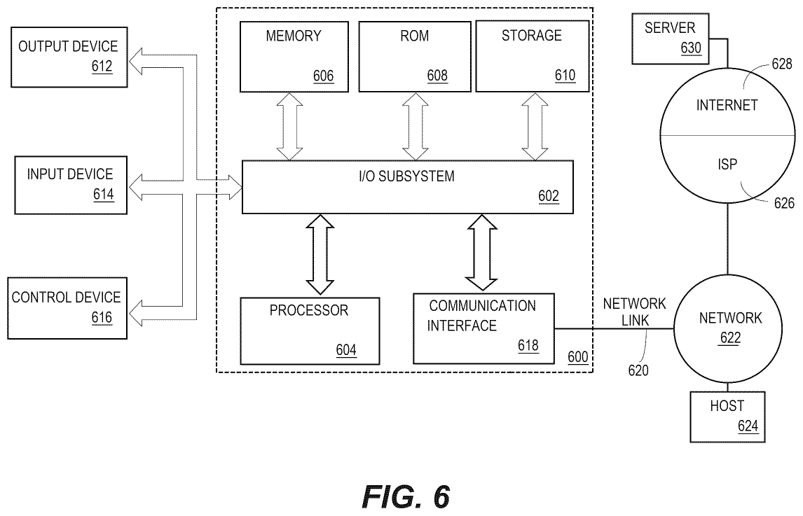

FIG. 6 is a block diagram that illustrates an example computer system with which an embodiment may be implemented. In the example of FIG. 6, a computer system 600 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 600 includes an input/output (I/O) subsystem 602, which may include a bus and/or other communication mechanism(s) for communicating information and/or instructions between the components of the computer system 600 over electronic signal paths. The I/O subsystem 602 may include an I/O controller, a memory controller, and at least one I/O port. The electronic signal paths, such as lines, unidirectional arrows, or bidirectional arrows, are represented schematically in the drawings.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system, a graphics processing unit (GPU), a digital signal processor, or an ARM processor. Processor 604 may comprise an integrated arithmetic logic unit (ALU) or be coupled to a separate ALU.

Computer system 600 includes one or more units of memory 606, such as a main memory, coupled to I/O subsystem 602 for electronically digitally storing data and instructions to be executed by processor 604. Memory 606 may include volatile memory such as various forms of random-access memory (RAM) or other dynamic storage device. Memory 606 may also be used to store temporary variables or other intermediate information during the execution of instructions to be executed by processor 604. Such instructions, when stored in non-transitory computer-readable storage media accessible to processor 604, can render computer system 600 into a special-purpose machine customized to perform the operations specified in the instructions.

Computer system 600 includes non-volatile memory such as read-only memory (ROM) 608 or other static storage devices coupled to I/O subsystem 602 for storing information and instructions for processor 604. The ROM 608 may include various forms of programmable ROM (PROM), such as erasable PROM (EPROM) or electrically erasable PROM (EEPROM). A unit of persistent storage 610 may include various forms of non-volatile RAM (NVRAM), such as FLASH memory, solid-state storage, magnetic disk, or optical disks such as CD-ROM or DVD-ROM and may be coupled to I/O subsystem 602 for storing information and instructions. Storage 610 is an example of a non-transitory computer-readable medium that may be used to store instructions and data which, when executed by the processor 604, cause performing computer-implemented methods to execute the techniques herein.

The instructions in memory 606, ROM 608, or storage 610 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 600 may be coupled via I/O subsystem 602 to at least one output device 612. In one embodiment, output device 612 is a digital computer display. Examples of a display that may be used in various embodiments include a touchscreen display, a light-emitting diode (LED) display, a liquid crystal display (LCD), or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections, or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. The control device 616 may be a touchpad, a mouse, a trackball, or cursor direction keys for communicating direction information and command selections to processor 604 and for controlling cursor movement on an output device 612, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 614 may include a combination of multiple input devices, such as a video camera and a depth sensor.

In another embodiment, computer system 600 may comprise an Internet of Things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders, and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware, and interfaces for generating position reporting packets, notifications, pulse or heartbeat signals, or other recurring data transmissions that specify a position of the computer system 600, alone or in combination with other application-specific data, directed toward host computer 624 or server computer 630.

Computer system 600 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 600 in response to processor 604 executing at least one sequence of at least one instruction contained in main memory 606. Such instructions may be read into memory 606 from another storage medium, such as storage 610. Execution of the sequences of instructions contained in memory 606 causes processor 604 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 602. Transmission media can also be acoustic or light waves generated during radio-wave and infrared data communications.

Various forms of media may carry at least one sequence of at least one instruction to processor 604 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to a bus or I/O subsystem 602. Communication interface 618 provides a two-way data communication coupling to a network link(s) 620 directly or indirectly connected to at least one communication network, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 622 broadly represents a local area network (LAN), wide-area network (WAN), campus network, internetwork, or any combination thereof. Communication interface 618 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may connect through network 622 to a host computer 624.

Furthermore, network link 620 may connect through network 622 or to other computing devices via internetworking devices and/or computers operated by an Internet Service Provider (ISP) 626. ISP 626 provides data communication services through a worldwide packet data communication network called Internet 628628. A server computer 630 may be coupled to Internet 628628. Server computer 630 broadly represents any computer, data center, virtual machine, or virtual computing instance with or without a hypervisor or computer executing a containerized program system such as DOCKER or KUBERNETES. Server computer 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server computer 630 may form elements of a distributed computing system that includes other computers, a processing cluster, a server farm, or other organizations of computers that cooperate to perform tasks or execute applications or services. Server computer 630 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 630 may comprise a web application server that hosts a presentation layer, application layer, and data storage layer, such as a relational database system using a structured query language (SQL) or no SQL, an object store, a graph database, a flat file system or other data storage.

Computer system 600 can send messages and receive data and instructions, including program code, through the network(s), network link 620, and communication interface 618. In the Internet example, server computer 630 might transmit a requested code for an application program through Internet 628628, ISP 626, a local network such as network 622, and communication interface 618. The received code may be executed by processor 604 as it is received and/or stored in storage 610 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. Accordingly, the specification and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method executed using one or more processors of a computer system, the computer-implemented method comprising:
accessing one or more data sets of information associated with an undeployable version of at least a portion of an in-development software application, wherein the undeployable version includes a copy of at least a portion of a deployable version of the in-development software application;
generating a prompt based on the one or more data sets of information, wherein generating the prompt includes generating a plurality of sub-prompts to be provided to a machine-learning model trained to generate a prediction of a summary of a merge request, the merge request being a request to merge the at least a portion of the undeployable version with the deployable version;
inputting the prompt into the machine-learning model trained to generate the prediction of the summary of the merge request;
outputting, by the machine-learning model, the prediction of the summary of the merge request, wherein the prediction of the summary of the merge request includes an indication of a set of edits to the undeployable version with respect to the deployable version; and
transmitting the summary of the merge request to one or more computing devices associated with an entity identified for approving the merge request.

2. The computer-implemented method of claim 1, further comprising causing the one or more computing devices associated with the entity to display a chat message corresponding to the summary of the merge request.

3. The computer-implemented method of claim 1, wherein the undeployable version of the in-development software application comprises one or more feature branches of a workflow associated with the in-development software application.

4. The computer-implemented method of claim 3, wherein the deployable version of the in-development software application comprises a master branch of the workflow associated with the in-development software application.

5. The computer-implemented method of claim 1, wherein generating the prompt comprises generating one or more of an N-shot prompt, a chain-of-thought (COT) prompt, or a generated knowledge prompt.

6. The computer-implemented method of claim 1, further comprising:
inputting the prompt into the machine-learning model by transmitting the prompt to one or more large language models (LLMs) utilizing an application programming interface (API) associated with the one or more LLMs; and
outputting, by the machine-learning model, the prediction of the summary of the merge request by receiving a response from the one or more LLMs.

7. The computer-implemented method of claim 1, wherein outputting the prediction of the summary of the merge request further comprises:
dividing the merge request into a plurality of subsets of information, wherein each of the plurality of subsets of information comprises a text file including one or more edits of the set of edits to the undeployable version;
for each of the plurality of subsets of information, inputting a first prompt into the machine-learning model configured to prompt the machine-learning model as trained to generate a prediction of a textual summary based on the subset of information; and
inputting a second prompt into the machine-learning model configured to prompt the machine-learning model as trained to generate a prediction of a final textual summary based on the predictions of textual summaries.

8. The computer-implemented method of claim 7, wherein dividing the merge request further comprises dividing the merge request into a plurality of text files in accordance with a token threshold associated with the machine-learning model.

9. The computer-implemented method of claim 8, wherein the token threshold comprises a threshold of approximately 4,000 tokens, approximately 8,000 tokens, approximately 16,000 tokens, or approximately 32,000 tokens.

10. The computer-implemented method of claim 1, further comprising:
prior to inputting the prompt into the machine-learning model, extracting from a text of the merge request a checklist to be included in the summary of the merge request.

11. The computer-implemented method of claim 1, wherein outputting the prediction of the summary of the merge request comprises outputting, by the machine-learning model, the prediction of the summary of the merge request in a specified format.

12. The computer-implemented method of claim 11, wherein the specified format comprises a JavaScript Object Notation (JSON) file including a plurality of specified sections, each of the plurality of specified sections corresponding to a different code review criterion.

13. The computer-implemented method of claim 12, wherein the plurality of specified sections comprises two or more of a file-path section, a change summary section, a change size section, a change complexity section, a change risks section, a time to review section, a code review comments section, or a checklist review section.

14. The computer-implemented method of claim 1, wherein the machine-learning model comprises a large language model (LLM).

15. The computer-implemented method of claim 14, wherein the LLM comprises one or more of ChatGPT 3.5, ChatGPT 4.0, Bard, LLaMa, LLaMa-2, or Code LLaMa.

16. The computer-implemented method of claim 1, further comprising:
prior to transmitting the summary of the merge request to the one or more computing devices associated with the entity, selecting the entity identified for approving the merge request based on a specified criterion for selecting entities for approving merge requests.

17. The computer-implemented method of claim 16, wherein the specified criterion for selecting entities for approving merge requests comprises one or more of an availability of an entity, a likelihood of an entity to accept the merge request, a familiarity of an entity with a content of the merge request, a current workload of an entity, a current connectivity status of an entity, or a priority level associated with the merge request.

18. One or more non-transitory computer-readable storage media storing one or more sequences of instructions, execution of which by one or more processors of a computing system causes the computing system to perform:
accessing one or more data sets of information associated with an undeployable version of at least a portion of an in-development software application, wherein the undeployable version includes a copy of at least a portion of a deployable version of the in-development software application;
generating a prompt based on the one or more data sets of information, wherein generating the prompt includes generating a plurality of sub-prompts to be provided to a machine-learning model trained to generate a prediction of a summary of a merge request, the merge request being a request to merge the at least a portion of the undeployable version with the deployable version;
inputting the prompt into the machine-learning model trained to generate the prediction of the summary of the merge request;
outputting, by the machine-learning model, the prediction of the summary of the merge request, wherein the prediction of the summary of the merge request includes an indication of a set of edits to the undeployable version with respect to the deployable version; and
transmitting the summary of the merge request to one or more computing devices associated with an entity identified for approving the merge request.

19. A computer system comprising:
one or more processors; and
one or more non-transitory computer-readable storage media storing one or more sequences of instructions, execution of which by the one or more processors causes the computer system to perform:
accessing one or more data sets of information associated with an undeployable version of at least a portion of an in-development software application, wherein the undeployable version includes a copy of at least a portion of a deployable version of the in-development software application;
generating a prompt based on the one or more data sets of information, wherein generating the prompt includes generating a plurality of sub-prompts to be provided to a machine-learning model trained to generate a prediction of a summary of a merge request, the merge request being a request to merge the at least a portion of the undeployable version with the deployable version;
inputting the prompt into the machine-learning model trained to generate the prediction of the summary of the merge request;
outputting, by the machine-learning model, the prediction of the summary of the merge request, wherein the prediction of the summary of the merge request includes an indication of a set of edits to the undeployable version with respect to the deployable version; and
transmitting the summary of the merge request to one or more computing devices associated with an entity identified for approving the merge request.
